(19) United States
(12) Patent Application Publication
(10) Pub. No.: US 2004/0264433 A1
(43) Pub. Date: Dec. 30, 2004

(54) Wireless communication arrangements with header compression

(76) Inventor: Diego Melpignano, Monza (IT)

Correspondence Address: Philips Electronics North America Corporation, P O Box 3001, Briarcliff Manor, NY, 10510, US

(21) Appl. No.: 10/494,395

(22) PCT Filed: Oct. 24, 2002
(86) PCT No.: PCT/IB02/04459

(30) Foreign Application Priority Data
Nov. 6, 2001 (EP) 01204215.6

(51) Int. Cl. H04J 3/24

(52) U.S. Cl. 370/349

(57) ABSTRACT

A method for wireless transmission between a first unit AP and a second unit MT is disclosed. The method includes a said unit AP, MT converting a real-time bit stream (e.g. VoIP, Audio, payloads of predetermined maximum length. One or more predefined headers (RTP/UDP/IP) is applied to the or each said payload so as to generate packets suitable for transmission between said units AP, MT in accordance with a protocol. The or each packet is then encapsulated within a frame of an encapsulation protocol (BNEP) adapted for transporting the or each packet across a wireless connection between the units MT, AP. A predefined header compression technique (IETF ROHC) is then applied to the or each encapsulated packet.

The present invention relates to wireless communication arrangements and to methods of operating the same, in particular to a packet-based wireless communications arrangement and to a method of operating the same in which header compression is used. The present invention also relates to communications units and to software products used in such arrangements.

Wireless communications systems based on radio units and connections used to group them at least temporarily into a shared resource network are known. One current implementation of this general type is in the form of a short-range, frequency-hopping network and is known in the art as Bluetooth™ communications. This arrangement is controlled by the Bluetooth™ standard and a full specification for conformity in Bluetooth™ communications can be found through the Bluetooth™ Special Interests Group (SIG), whose web site can be found at “www.bluetooth.com” along with the current Bluetooth™ standard u and related information.

A useful discussion of Bluetooth™ communications can be found in text book form in “Bluetooth™, Connect Without Wires” by Jennifer Bray and Charles F. Sturman, published by Prentice Hall PTR under ISBN 0-13-089840-6.

Further prior art can be found in, for example, WO 01/20940, U.S. Pat. No. 5,940,431 and in U.S. published applications 2001/0005368A1 and 2001/0033601A1, in which some aspects of the current state of the art in this field are also discussed.

The reader is referred to the above mentioned sources for general Bluetooth™ background information and also, for example, for clarification of terms of art used herein and not specifically defined.

Each access point in a Bluetooth™ network forms a Bluetooth™ piconet with one or more mobile terminals, such as for example mobile telecommunications handsets. This Bluetooth™ PAN may carry VoIP flows as well as other types of IP traffic. Since many handsets (or other terminals) may be attached to the same access point, it can be seen that it is important to maximize efficiency in the usage of the limited bandwidth available (1 Mbps gross aggregate capacity per piconet).

An emerging application for Bluetooth™ is the delivery of Voice over Internet Protocol (VoIP), which is being deployed over the internet as well as in corporate networks/intranets. In the latter case, the main advantage of VoIP is its use by voice traffic of an existing network infrastructure typically used for data. When VoIP traffic has to be carried over a wireless link with limited bandwidth, however, it is important to minimize bandwidth waste since VoIP flows are delay-sensitive and show considerable header overheads.

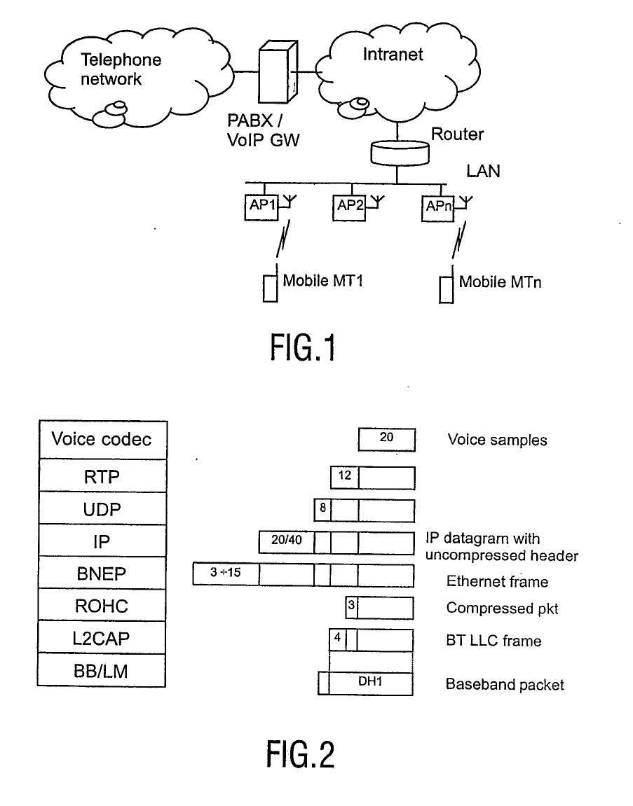

The architecture depicted in FIG. 1 shows a possible scenario in which one MT₁ of a group of mobile terminals MT₁₋ₙ comprises a Bluetooth™ enabled third generation (3G) mobile telephone which has an embedded IP stack and is capable of operation as a cordless phone handset by establishing VoIP connections inside a corporate network such as an intranet. The mobile handset MT₁ uses a set of access points AP_{1 . . . n} in the intranet to establish a voice-over-IP (VoIP) connection, which may be made either through a dedicated gateway (PABX/VoIP GW) to a telephone network or within the intranet, e.g. with one or more other handsets MTₙ.

According to the VoIP paradigm, voice samples are compressed into packets whose length depends on the voice coder being used. Such payload length must be limited to avoid introducing long delays in conversations. For GSM quality, a G;723.1 coder at 5.3 kb/s can be used, which produces voice packets of 20 bytes. This payload is time stamped using the Real-Time Protocol (RTP), which introduces a 12-byte header and the resulting segment is carried in a UDP datagram, which adds a further 8-byte header of its own. While RTP provides the facilities for time synchronization, UDP allows several streams to be multiplexed together into a connectionless logical channel. This RTP/UDP packet is then encapsulated into an IP datagram, which adds a 20-byte IP header. The situation may worsen still further if IP version 6 (IPv6) is used, because the IP header then increases from 20 bytes to 40 bytes, giving a potential total header of 60 bytes for a payload of only 20 bytes. This low efficiency in bandwidth utilization may not be a major problem when VoIP packets are carried over a wired LAN, but may cause serious limitations when a wireless LAN is used instead.

In the particular case of Bluetooth™ communications, the Personal Area Network (PAN) working group standardizes IP over Bluetooth™ and, for this purpose, has developed a new protocol named the “Bluetooth™ Network Encapsulation Protocol” (BNEP). This protocol defines a packet format for Bluetooth™ network encapsulation used to transport common networking protocols over the Bluetooth™ media. The BNEP provides an Ethernet emulation for Bluetooth™, by which IP datagrams are encapsulated into Ethernet frames and sent to the underlying L2CAP layer. By introducing the Ethernet emulation layer, it is possible to implement broadcasting, multicasting and Layer-2 bridging functions, e.g. in network access points or in Bluetooth™ ad-hoc networks. Full details of the BNEP can be obtained through the Bluetooth™ SIG and their website referred to above.

While being very flexible, however, BNEP introduces a big overhead despite its own header compression mechanism. When summing BNEP to the overhead of higher layer protocols, considerable waste of bandwidth may result for some applications. For example, in the case of the VoIP application discussed above, encapsulating the RTP/UDP/IP packets using BNEP would add between 3 and 15 more bytes to the already long header, thus leading to an overall header of at least (12+8+20+3=43) up to a possible (12+8+40+15=75) bytes for a 20 byte payload. Similar considerations apply to other types of IP traffic, for example media such as audio and/or video signals. In these latter cases, packets generated by audio/visual applications may be bigger than VoIP packets, but it is still important to minimize header overheads. In fact, when the Bluetooth system is used, it is usual for an audio/visual coder to generate packets which can be mapped one-to-one to an L2CAP frame. This allows better retransmission control and eases buffer flushing whenever the useful packet lifetime has expired. If the header dimension is minimized, given the useful payload of a baseband packet, more bandwidth is reserved for the actual audio/visual payload.

It is an object of the present invention to provide improved wireless communication arrangements and improved methods of operating the same. It is a further object of the present invention to provide an improved packet-based wireless communications arrangement, and an improved method of operating the same, in which header compression is used. It is a further object of the present invention to provide improved communications units and software products used in association with such improved communications arrangements and methods. In this manner, it is a particular object of this invention to provide reduced overhead due to RTP/UDP/IP/BNEP headers for internet protocol (IP) bit streams such as VoIP, Audio and/or Video in a Bluetooth™ Personal Area Network.

Accordingly, the present invention provides a method for wireless transmission between a first unit and a second unit, the method including a said unit:

a) converting a real-time bit stream into one or more payloads of predetermined maximum length;

b) applying one or more predefined headers to the or each said payload so as to generate packets suitable for transmission between said units in accordance with a predefined communications protocol;

c) encapsulating the or each said packet within a frame of an encapsulation protocol adapted for transporting the or each said packet across a wireless connection between said units; and

d) applying a predefined header compression technique to the or each said encapsulated packet.

The method may include generating the or each said payload from a said real time bit stream comprising Internet Protocol (IP) traffic, such as Voice-over-Internet-Protocol (VoIP), audio or visual streams.

The method may include performing a service discovery procedure between said first and second units and advertising said header compression technique during said service discovery procedure.

The method may include configuring one or more of segmentation, re-assembly and multiplexing services of said predefined communications protocol to carry a compressed bitstream.

The method may include applying said header compression by adding encapsulation protocol information to the context of a compressor and decompressor adapted to apply said header compression technique, said information comprising for example static header fields of said encapsulation protocol.

Said units may comprise part of a radio communications network suwh as a Bluetooth™ network and said method may include encapsulating the or each said packet using an encapsulation protocol comprising a Bluetooth™ Network Encapsulation Protocol (BNEP).

The method may include compressing with said header compression technique the or each said encapsulated packet into a single slot Bluetooth™ baseband packet, preferably by shrinking a combination of said predetermined headers and a BNEP header to a predetermined length, for example three bytes.

The method may include applying said header compression technique in the form of a Robust Header Compression (ROHC) framework, such as an ROHC approved by the Internet Engineering Task Force (IETF).

The method may include one or more of the following:

a) using the Real Time Protocol (RTP) profile for said packets;

b) using the IETF ROHC bi-directional optimistic approach (o-mode);

c) using small ROHC Context Identifiers (R-CID), with null R-CID being a default;

d) transmitting no Universal Datagram Protocol (UDP) checksum, optionally recalculating it at a decompressor,

e) considering, during any one packet flow, the whole encapsulation protocol header as part of the static context;

f) transmitting only the Real Time Protocol (RTP) Sequence Number and/or the Internet Protocol identity;

g) defining transitions among “Initialization and Refresh” (IR), “First Order” (FO) and “Second Order” (SO) states in a compressor and among “No Context” (NC), “Static Context” (SC) and “Full Context” (FC) states in a decompressor.

The method may include classifying encapsulation frames such that only predetermined said frames are compressed using said header compression technique.

The method may include applying headers to said payload in accordance with one or more of Real Time Protocol (RTP), Universal Datagram Protocol (UDP) and Internet Protocol (IP).

The method may include said units configuring a plurality of logical channels for communication therebetween, at least one said channel being dedicated to transport of said compressed encapsulated packets.

The method may include basing said header compression technique on Window-Least Significant Bit coding (W-LSB).

The method may include governing switching between compressor and decompressor states by providing a feedback channel between said units adapted for error recovery requests and, optionally, for acknowledgements of context updates.

The method may include a said unit receiving a succession of said compressed encapsulated frames segmented into baseband packets, positively acknowledging each said packet before a next said packet is transmitted and, in the event that a transmission error occurs in either the latest said packet or an acknowledgement message, said latest packet is retransmitted.

The method may include retransmitting said packet in the event of at least one of the following:

a) a baseband packet access code is not received;

b) an uncorrectable error is present in a baseband packet header, or

c) an uncorrectable error is present in said payload of said packet.

The method may include limiting a number of retransmissions for a said compressed encapsulated frame, for example by setting a timeout for successful delivery of said frame.

The present invention also provides a software product for executing packet-based wireless communication between a first communications unit and a second communications unit, the product including code for:

a) converting a real-time bit stream into one or more payloads of predetermined maximum length;

b) applying one or more predefined headers to the or each said payload so as to generate packets suitable for transmission between said units in accordance with a predefined communications protocol;

c) encapsulating the or each said packet within a frame of an encapsulation protocol adapted for transporting the or each said packet across a wireless connection between said units; and

d) applying a predefined header compression technique to the or each said encapsulated packet.

Said software product may be run in association with a Bluetooth™ network interface software driver forming part of a said communications unit.

The present invention also provides a packet-based wireless communications arrangement comprising a first unit adapted to communicate information to a second unit substantially in real-time, said first unit being adapted to:

a) convert a real-time bit stream into one or more payloads of predetermined maximum length;

b) apply one or more predefined headers to the or each said payload so as to generate packets suitable for transmission between said units in accordance with a predefined communications protocol;

c) encapsulate the or each said packet within a frame of an encapsulation protocol adapted for transport of the or each said packet across a wireless connection between said units; and to

d) apply a predefined header compression technique to the or each said encapsulated packet.

Said first unit may be operable in accordance with the Bluetooth™ protocol, said encapsulation protocol preferably comprising a Bluetooth Network Encapsulation Protocol (BNEP) and said header compression technique preferably being compatible with an Internet Engineering Task Force (IETF) Robust Header Compression (ROHC) technique.

The present invention also provides a communications unit adapted to operate in accordance with a method according to the present invention, said unit preferably comprising a master unit or a slave unit of a Bluetooth network, such as an access point or a mobile terminal. Header compression and or decompression of encapsulated packets may be implemented in the form of a software product run in a Bluetooth™ network interface software driver associated with said communications unit. This software product may include Bluetooth Network Encapsulation Protocol (BNEP) and Logical Link Control and Adaptation protocol (L2CAP) layers, a frame classifier, a Robust Header Compression (ROHC) codec and a Management Entity (ME) for co-ordination. The management entity may communicate with the Bluetooth™ baseband through a Host Controller Interface (HCI) and with upper protocol layers by means of operating-system specific mechanisms. Each time a slave communications unit, e.g. embodied as a mobile terminal MT₁₋ₙ, connects to a master unit, e.g. embodied as an access point AP₁₋ₙ, the management entity may register its medium access address (MAC) and may configure logical channels for said slave unit.

FIG. 1 is a schematic diagram of a communications system;

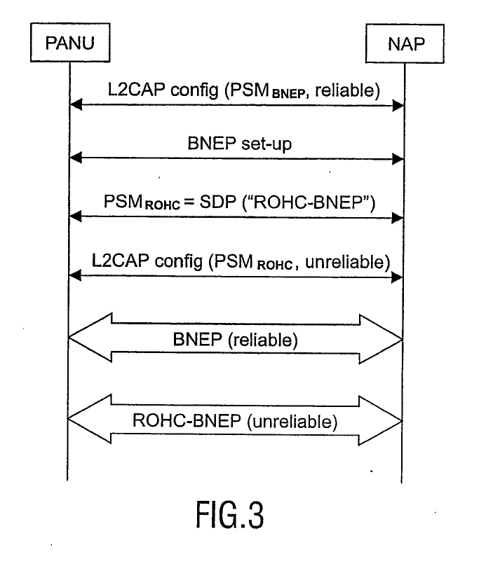

FIG. 2 is a protocol stack for a communications unit according to an embodiment of the present invention and which is suitable for use in a system according to FIG. 1;

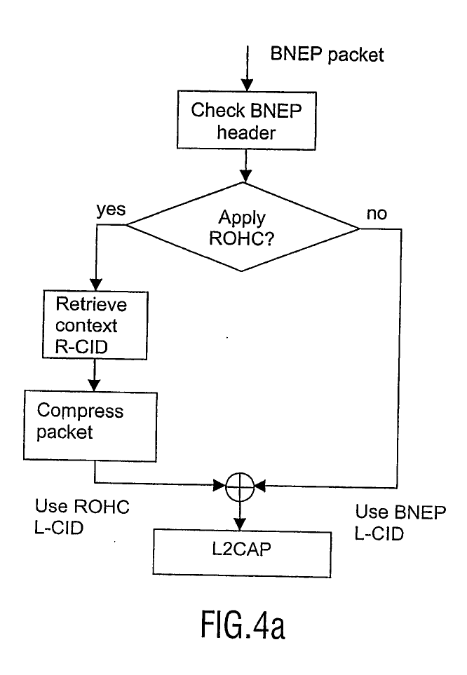

FIG. 3 is a flow diagram of network configuration for the communications unit of FIG. 2;

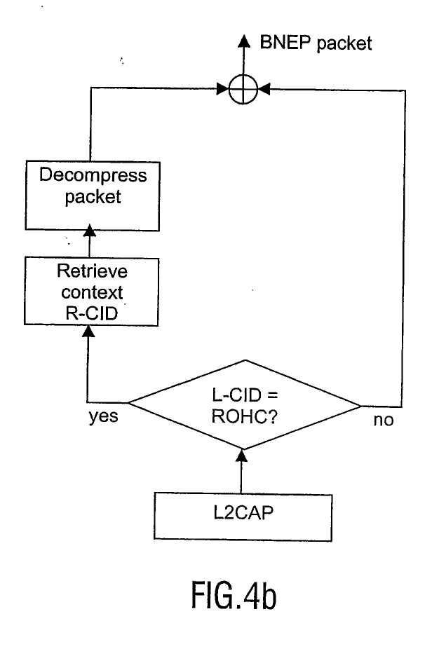

FIG. 4a is a flow diagram of a header compressor used in implementing the present invention;

FIG. 4b is a flow diagram of a header decompressor used in implementing the present invention;

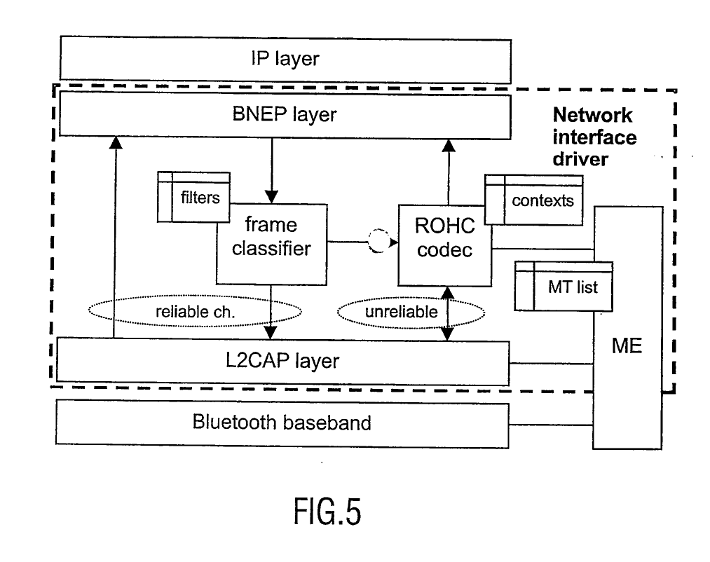

FIG. 5 is a functional diagram of an embodiment of the present invention;

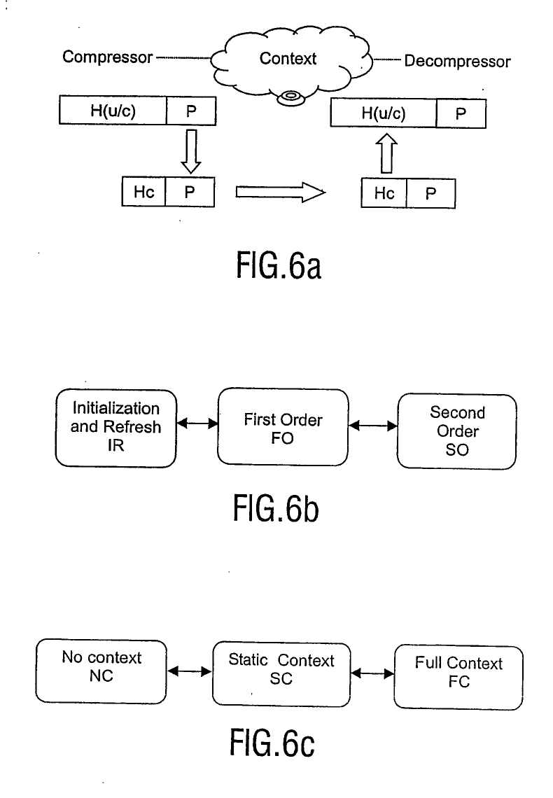

FIG. 6a is a schematic diagram of a header compression and decompression chain;

FIG. 6b is a block diagram of compressor states;

FIG. 6c is a block diagram of decompressor states; and

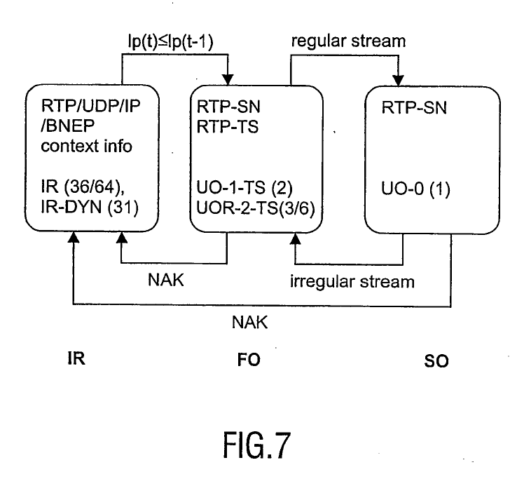

FIG. 7 is a state machine for a header compressor of FIG. 4a.

The present invention will now be described with reference to certain embodiments and with reference to the above mentioned drawings. Such description is by way of example only and the invention is not limited thereto. In particular reference will be made to packets and packet based communications systems. The skilled person will appreciate that the present invention is not limited to packet switched systems but can be applied to any system using packets as means for transmitting data, i.e. independent of whether it is a packet switched, circuit switched or a another system. The reference to “wireless” should be understood in its widest sense. For example, it may include any system which does not rely for some of its transmissions on a wireline network, for instance it includes optical transmission methods such as diffuse infra-red. It will be noted, however, that all the embodiments of the present invention can be used with the Bluetooth™ protocol. The features of such a system may include one or more of:

Slow frequency hopping as a spread spectrum technique;

Master and slave units whereby the master unit can set the hopping sequence;

Each device has its own clock and its own address;

The hopping sequence of a master unit can be determined from its address;

A set of slave units communicating with one master all have the same hopping frequency (of the master) and form a piconet;

Piconets can be linked through common slave units to form a scatternet;

Time Division Multiplex Transmissions (TDMA) between slave and master units;

Time Division Duplex (TDD) transmissions between slaves and masters units;

Transmissions between slave and master units may be either synchronous or asynchronous;

Master units determine when slave units can transmit;

Slave units may only reply when addressed by a master unit;

The clocks are free-running;

Uncoordinated networks, especially those operating in the 2.4 GHz license-free ISM band;

A software stack to enable applications to find other Bluetooth™ devices in the area;

Other devices are found by a discovery/inquiry procedure; and

Hard or soft handovers.

With regard to frequency hopping, “slow frequency hopping” refers to the hopping frequency being slower than the modulation rate, “fast frequency hopping” referring to a hopping rate faster than the modulation rate. The present invention is not limited to either slow or fast hopping.

In the following reference will be made to user terminals being mobile terminals however the present invention is not limited thereto but also includes fixed user terminals, such as a computer.

Reference will be made herein to header compression techniques, and in particular to Robust Header Compression (ROHC). It is considered useful to provide a summary of some aspects of these techniques but, for a more detailed understanding, the reader is referred to the July 2001 article:

“Robust Header Compression (ROHC): Framework and four profiles: RTP, UDP, ESP and uncompressed” by C. Borman et al., which can be found via the “Internet Engineering Task Force” (IETF) website under the reference “RFC3095” and is accessible through the URL:

http://www.ietf.org/rfc/rfc3095.txt

In general, header compression mechanisms reduce header overhead by taking advantage of the fact that it is not necessary to send static header fields in every packet because they do not change during a session, such static header fields comprising for example IP addresses and UDP ports. Furthermore, it is possible to efficiently handle the fields that change during the sessions (e.g. RTP timestamp, RTP sequence number and IP identification), so that header overhead can be reduced even more. In some cases, these so-called “changing fields” can be predicted from previous packets using a simple linear extrapolation. Other header fields (e.g. IP header length and UDP length) can be inferred from data-link level and it is not necessary to transmit them, these fields being referred to as “inferred fields”.

A header compression scheme was proposed by S. Casner and V. Jacobson in their February 1999 article “Compressing IP/{UDP/RTP Headers for Low-Speed Serial Links” (Internet RFC 2508). This arrangement compresses RTP/UDP/IP headers, but was not designed to handle the error rates and round-trip delay encountered on typical wireless links.

Techniques have been proposed for adapting header compression to the wireless environment, such as for example “ACE” (Adaptive header Compression) and “ROCCO” (Robust Checksum-based header Compression). “ACE” introduces a field encoding scheme “changing fields” (“Window-based Least Significant BIT” W-LSB) that uses a number of reference values contained in a variable sliding window (VSW), which are communicated to the decompressor. ROCCO uses a CRC to verify correct reconstruction in the decompressor and to avoid error propagation.

The IETF ROHC Working Group is currently studying new compression schemes that work well over links with high error rates and long round-trip times. The schemes must perform well for cellular links built using technologies such as WCDMA, EDGE, and CDMA-2000. However, the schemes should also be applicable to other future link technologies with high loss and long roundtrip times, such that compression may be achieved over unidirectional links. The IETF ROHC uses and combines all techniques studied by ACE and ROCCO and details may be found through the IETF ROHC Working Group URL at:

http://www.ietf.org/html.charters/rohc-charter.html

ROHC provides an extensible framework for robust header compression that is applicable to RTP/UDP/]P streams over wireless channels. Support for compression of TCP/IP headers and other kinds of protocols (e.g. Mobile IPv6) is also being added and to date four profiles have been defined by the ROHC RFC:

0 Uncompressed IP packets

1 RTP/UDP/IP

2 UDP/IP

3 ESP/IP

The present invention concentrates on profile 1.

The ROHC compressor and decompressor need to maintain context information so that dynamic fields of the real-time flow are correctly processed and headers reconstructed accordingly, while static header fields, i.e. those that remain unchanged within a given context, are not transmitted at all. A diagram of a compression and decompression chain can be seen with particular reference to FIG. 6a.

For an RTP/UDP/IP flow, the dynamic fields are listed below:

IP Identification (16 bits) IP-ID

UDP checksum (16 bits)

RTP marker (1 bit) M-bit

RTP Sequence Number (16 bits) SN

RTP Timestamp (32 bits) TS

All other header fields are either static or inferred.

Initially the compressor is in the “Initialization and Refresh” (IR) state, where the headers are sent non-compressed so that the decompressor can create a context for the IP flow. In the “First Order” (FO) state, the compressor only sends updates of the static fields to the decompressor to compensate for irregularities in the stream that may corrupt the context. Therefore, in this state, the compressor sends only context updates. In the “Second Order” (SO) state, the compressor sends compressed headers since it is confident that the decompressor has already received a valid context. Please see in particular FIG. 6b.

The decompressor starts in a “No-Context” (NC) state. Upon successful decompression of a header, it goes to “Full Context” (FC) state, which is the normal operating state. Only after repeatedly decompressing headers does it go to a “Static Context” (SC) state, in which it waits for context update packets sent by the compressor in the FO state. If a valid context cannot be recovered, the decompressor returns to the NC state. Please see in particular FIG. 6c.

Transitions between states are governed by operating modes, of which ROHC defines three: “unidirectional” (U-mode), “bi-directional optimistic” (O-mode) and “bi-directional reliable” (R-mode). In U-mode, a feedback channel from the decompressor to the compressor does not exist (or cannot be used) so that transitions between compressor states are based on only periodic timeouts and irregularities in the incoming packet headers. In this case, periodic refreshes of the context are needed. In the O-mode, a feedback channel is used for error recovery requests and (optionally) acknowledgements of context updates. The rational behind this operating mode is to minimize the use of the feedback channel. Finally, the R-mode makes intensive use of the feedback channel in order to maximize robustness against loss propagation and damage propagation.

W-LSB Encoding:

Given a header field value to compress “v”, the W-LSB algorithm transmits only its least significant bits, provided a suitable reference value (v_ref) is maintained both at the compressor and at the decompressor. In order to avoid mismatches between “v_ref” values, a suitable robust algorithm is defined which selects “v_ref” within a variable sliding window VSW. The number of least significant bits “k” to transmit for the value “v” to be compressed is selected as explained below.

Let:

f(v_{—}ref,k)=[v_{—}ref−p,v_{—}ref+(2^{k-1})−p] (1)

be an interval in which v is expected to vary. The offset parameter p can be chosen according to the behavior of the specific field to compress.

Now, at the compressor the value k could be chosen in such a way that:

k=g(v_{—}ref,v)=mink:vεf(v_{—}ref,k) (2)

So k would be the minimum value such that v falls in the interval f(v_ref, k).

However, this scheme might not be robust against errors because the compressor has no knowledge that the decompressor is using the same reference value (which could actually be different because of transmission errors). Instead, a variable sliding window is introduced:

VSW={v_{i-w},vᵢ) (3)

which contains the last w values that have been transmitted. Whenever a new value enters the compressor, it is appended to VSW. When the compressor is sufficiently confident that some of the older values in VSW have been correctly received, those values are removed from VSW.

We define:

vₘᵢₙ=min(VSW), vₘₐₓ=max(VSW) (4)

as the minimum and maximum values in VSW.

In the W-LSB coding scheme, the selection of k is made according to the following formula:

k=max(g(v,vₘᵢₙ), g(v,vₘₐₓ)) (5)

where g( ) has been defined in (2).

In this way, a higher number of bits is used to encode the field due to the uncertainty that the decompressor has a good reference interval for decoding the transmitted m bits. In fact, the decoding technique at the decompressor is based on the following algorithm.

Let:

I_{d}=f(v_{—}ref_{—}d,m) (6)

be defined as the interpretation interval given the last correctly decompressed value v_ref_d and the number of bits received m. The decompressed field is simply derived by picking the value in the above interpretation interval whose m least significant bits match the received m bits.

The size w of the variable sliding window depends on the confidence that the compressor has on the decompressor state, which in turn depends on the selected ROHC mode. For U and O modes, w is implementation dependent. The syntax of the ROHC compressed packets (defined later) sets the allowed dimensions of w. In fact, since each packet type has a certain number of bits reserved for a coded header field, this automatically defines the window dimension. For example, the RTP-SN is reserved four bits in the UO-O packet, which means the window length is set to 16 (i.e. up to 15 packets can be lost). In R-mode explicit feedback from the decompressor can be used to minimize the sliding window dimension and therefore maximizing the compression ratio.

The W-LSB algorithm may be further explained through a simple example. Let us assume that the compressor has transmitted the values 151, 152, 153, 154 and 155 and that the last three ones have not been received because of transmission errors on the wireless link. Then, at the compressor:

VSW=[151,152,153,154,155], vₘᵢₙ=151 and vₘₐₓ=155.

Now the value 156 enters the compressor. The number of least significant bits k to transmit is given by (5), which yields k=max (3,1)=3. So the last three LSBs of the value 156=‘10011100’ are transmitted (‘100’).

At the decompressor, since the values 153, 154 and 155 have been lost, the last good reference value is 152. According to (6), the decompressor has an interpretation interval I_{d}=[152, 159], which is expanded below.

| Dec | Bin |
|---|---|
| 152 | 10011000 |
| 153 | 10011001 |
| 154 | 10011010 |
| 155 | 10011011 |
| 156 | 10011100<<< |
| 157 | 10011101 |
| 158 | 10011110 |
| 159 | 10011111 |

It can be noticed that within this interval the only value whose three LSBs match the pattern ‘100’ is 156. The correctness of the decompression can be checked by applying a small CRC to the original header (e.g. 3 to 8 bits depending on mode). in order to avoid that an undetected transmission error leads to a wrong decompressed value, which, in turn, would be used later as a reference value, leading to damage propagation. Failure of the CRC to detect a damaged value is also compensated for in the ROHC framework.

Other Encoding Schemes:

The W-LSB coding algorithm is not the only one that can be used in the ROHC framework. Other schemes exist that take advantage of specific characteristics of some header fields such as, for example, the RTP timestamp, which usually increases in regular steps over time (multiple of a TS_STRIDE value). This characteristic is exploited by “scaled RTP timestamp” encoding.

RTP timestamp can also be approximated with a linear function of the time of day for traffic generated at constant rate, fixed sampling frequency and when packet generation is locked to the sampling frequency. In this case “timer-based compression of RTP timestamp” applies.

The IP identification field (IP-ID) is encoded by considering only offsets between the IP-ID and the RTP sequence number (the latter increases by one for each new packet) and applying W-LSB encoding to such offsets.

ROHC RTP Profile:

Constant header fields of the RTP/UDP/IP stream to be compressed can be structured as ordered lists. The ROHC framework provides means to handle these lists in such a way that list items (that form the context) in the decompressor can be flexibly inserted, removed or changed by the compressor.

The dynamic fields of the RTP header are encoded according to Table 1.

TABLE 1
RTP header dynamic fields coding.
The dynamic fields of the RTP header
are encoded according to Table 1.

| Field | Coding | Comments |
|---|---|---|
| RTP-SN | W-LSB | p = 2^{k-5} − 1, k > 4, p = 1 otherwise |
| IP-ID | Offset IP-ID | Unless IP-ID varies randomly |
| | | (RND flag <> 0) |
| TS | Timer-based | Depending on flag values in the |
| | Scaled RTP TS | header (TS-STRIDE, Tsc) |
| | No compression | p = 2^{k-2} − 1 |
| CRC | 3, 7 or 8 bits | Calculated over the original |
| | | uncompressed header |
| M bit | Only updated | Context initially set to 0 |
| | when it changes | |

The RTP TS and IP-ID fields can often be derived from the RTP SN, since IP-ID usually increases by the same delta as the sequence number and the timestamp by the same delta times a fixed value. Therefore, when these conditions apply, only the RTP SN is included in the compressed header and the functions to derive the other fields are included in the context.

A ROHC packet has the following format:

TABLE 2
ROHC packet.

| | |
|---|---|
| Padding | Optional, |
| | variable length |
| Feedback | 0 or more feedback elements |
| Header | Variable, with CID information |
| Payload | |

Each packet element in Table 2, with the exception of the payload, starts with a unique bit pattern.

Headers carry Context ID (CID) information: they may include a 1 byte ‘add-CID’ octet (starting with the pattern ‘1110’) for small CIDs between 1 and 15 or carry embedded CID information when the CID space is large (up to 2 bytes). An ROHC context identifier is referred to as R-CID. If CID=0 is not transmitted, the packet starts with the packet type, which is a unique bit pattern different from ‘1110’ and a null CID is implied.

Feedback information can be piggybacked to any ROHC packet and carries negative and positive acknowledgements for context updates and header decompression. Feedback packets can also be used by the decompressor to request transitions between modes (e.g. from U-mode to O-mode).

Packet Types:

Several packet types are defined by ROHC depending on their function, the mode used and which field is carried. The notation for ROHC packets is:

<Mode>-<Type>-<Optional Fields>

For example, an UOR-2 packet can be used in U-mode, O-mode or R-mode and is of type 2.

In the RTP profile three packet types are used to identify compressed headers and two for initialization and refresh as shown below:

0. (R-0, R-0-CRC,UO-0) this is the minimal packet type where only the W-LSB encoded RTP-SN is transmitted, since all the functions to derive the other fields are known at the decompressor.

1. 1(R-1, R-1-ID, R-1-TS, UO-1, UO-1-ID, UO-1-TS) this packet is used when the number of bits needed to encode the RTP-SN exceeds those available in packet type 0 or when the functions to derive RTP TS and IP-ID from RTP SN change.

2. (UOR-2, UOR-2-ID, UOR-2-TS) used to change parameters of any SN-function.

3. IR: this packet is used to communicate the static part of the context, i.e. the constant SN-functions

4. IR-DYN: this packet type is used to communicate the dynamic part of the context, i.e. the non-constant SN-functions.

The bit patterns that form unique prefixes for each of the packet types are shown in Table 3.

TABLE 3
Packet prefixes.

| Packet type | Pattern |
|---|---|
| Add-CID | 1110 |
| Padding | 11100000 |
| Feedback | 11110 |
| IR | 1111110 |
| IR-DYN | 11111000 |
| Segment | 1111111 |
| R-0 | 00 |
| R-0-CRC | 01 |
| UO-0 | 0 |
| R-1, R-1-ID, R-1-TS | 10 |
| UO-1, UO-1-ID, UO-1-TS | 10 |
| UOR-2, UOR-2-ID, UOR-2-TS | 110 |

Upon receiving a packet, the decompressor parses the first byte and consequently drives its state machine.

IR Packet:

The Initialization and Refresh (IR) packet allows the decompressor to create a context for the RTP/UDP/IP flow. Its structure is shown below in Table 4.

TABLE 4
IR packet format.

| | | |
|---|---|---|
| 0 | 7 | |
| Add-CID octet | | 1 |
| 1111110 | D | 1 |
| CID info (opt). | | 0-2, |
| | | large |
| | | CIDs |
| Profile | | 1 |
| CRC | | 1 |
| Static chain | | variable |
| Dynamic chain | | variable |
| | | present if D = 1 |
| Payload | | |

The Add-CID octet allows associating a context identifier to the static header information that is carried in the rest of the packet. The D bit is profile specific and, in the case of the RTP profile, it indicates the presence of a dynamic subheader information right after the static chain. The CID info field is present only if big context identifiers need to be used. The profile field is an identifier for the ROHC profile. An 8-bit CRC follows, to which end the reader is referred to “Robust Header Compression (ROHC): Framework and four profiles: RTP, UDP, ESP and uncompressed” by C. Borman et al., which can be found via the “Internet Engineering Task Force” (IETF) website under the reference “RFC3095”. See section 5.9.1 for the generator polynomial on which fields the value is computed.

The static chain contains the ordered list of static header fields. For example, an IPv4 header should be initialized with a static part that includes: version, protocol, source address and destination address. The dynamic part of the IPv4 header includes: type of service, time to live, Identification, DF, RND, NBO, extension header list. IR-DYN packet:

This type of packet is used to update the dynamic part of the context and its format is shown below in Table 5. Only the dynamic chain is carried in this case.

TABLE 5
IR-DYN packet format

| | | |
|---|---|---|
| 0 | 7 | |
| Add-CID octet (opt.) | | |
| 11111000 | | 1 |
| 0-2 octets CID info (opt.) | | |
| Profile | | 1 |
| CRC | | 1 |
| Dynamic chain | | variable |
| Payload | | |

General Packet Format:

The compressed packet format is shown in Table 6. It can be noticed that its structure depends on many conditions (Cx) so that its processing may not be obvious.

TABLE 6
General compressed packet format.

| | | |
|---|---|---|
| 0 | 7 | |
| Add-CID octet (opt.) | | |
| Base header | | 1 byte, |
| | | Type indication |
| 0-2 octets CID info (opt.) | | |
| Remainder of base header | | 1 |
| Extension | | Variable, C0 |
| IP-ID outer IPv4 header | | 2 bytes, C1 |
| AH data for outer list | | Variable |
| GRE checksum | | 2 bytes, C2 |
| IP-ID of inner IPv4 header | | 2 bytes, C3 |
| AH data for inner list | | Variable |
| GRE checksum | | 2 bytes, C4 |
| UDP checksum | | 2 bytes, C5 |

Conditions depend on values of previously decoded flag fields. Header extensions may be optionally present to carry additional ROHC information (four different extension types are defined). An IP-ID field may be present if the context indicates that this field varies randomly.

AH data refers to authentication headers, which contain values for security associations. The GRE checksum refers to GRE tunnels (RFC2784, RFC2890). The UDP checksum is present only when explicitly indicated in the context.

Robust Header Compression for Bluetooth™:

The present invention focuses on two main issues:

a) applying Robust Header Compression (ROHC) to the Bluetooth™ communication system; and

b) extending ROHC to BNEP.

The present invention provides a new protocol that is able to compress a VoIP frame, video/audio stream or equivalent, so that it fits into a single-slot Bluetooth™ baseband packet, this protocol being referred to herein for convenience as “ROHC-BNEP”.

The invention is not limited to voice applications only, but is also applicable to other IP traffic, such as Audio/Video streaming applications involving the transport of real-time IP services in a Bluetooth™ piconet. According to the present invention, BNEP information is added to the context of the ROHC compressor and decompressor. In this way, not only the IP packet is compressed, but also the layer-2 frame.

The protocol stack for a mobile handset MT₁₋ₙ according to an embodiment of the present invention can be seen with particular reference to FIG. 2. For each packet that the voice encoder produces, a 12-byte RTP header is added to allow time synchronization. An 8-byte UDP header is added which allows application flows to be multiplexed together and adds a header checksum. The UDP datagram is encapsulated into an IP packet, which has a 20-byte or a 40-byte header depending on whether IP version 4 or 6 is used. The BNEP header, used to encapsulate an IP packet into a Bluetooth™ frame, ranges from 3 to 15 bytes. It can be seen that robust header compression (ROHC) is applied to the BNEP frames that carry RTP/UDP/IP flows.

In order to carry the compressed frame in single-slot DH1 baseband packet, which has a 27-byte payload, and taking into account the 4-byte L2CAP header overhead, the RTP/UDP/IP/BNEP headers have to be shrunk to three bytes by the ROHC compressor. This target can be reached if the BT system and the ROHC compressor are properly configured, as explained below.

The proposed solution includes several steps:

advertising ROHC compression capabilities using the standard Bluetooth™ service discovery protocol;

configuring L2CAP channels to carry the compressed bitstream;

adding BNEP static header fields to the ROHC context (all BNEP header fields are static within a single VoIP session);

adapting the ROHC framework to the Bluetooth™ baseband retransmission scheme; and

classifying BNEP frames so that only those that carry a VoIP packet are compressed using the proposed ROHC-BNEP algorithm.

The generic ROHC framework has been referred to above. In the next sections, its application to the Bluetooth™ case will be detailed including the packet types to use, how to select them and how transitions among compressor states are governed. ROHC-BNEP uses the following tools:

The RTP profile is used;

ROHC bi-directional optimistic mode is the approach used: only NACKS are fed back in case of unsuccessful decompression and we try to minimize their usage whenever possible.

Small R-CID only, there is no need for large CID space, null R-CID is used as default, since it does not need to be transmitted.

No UDP checksum is transmitted (it can optionally be recalculated at the decompressor only in case the payload is not encrypted).

Since the whole BNEP header never changes for the same VoIP flow, it must be considered as part of the static context.

Only the RTP Sequence Number and/or the IP-ID are transmitted, since the function to derive the RTP TS is known (timer-based encoding is applied to compensate for silence suppression).

Feedback channel utilization is minimized so as to carry only context update requests from the decompressor to the compressor.

Transitions are defined among “Initialization and Refresh” (IR), “First Order” (FO) and “Second Order” (SO) states in a compressor and among “No Context” (NC), “Static Context” (SC) and “Full Context” (FC) states in a decompressor.

ROHC over Bluetooth™ is further specified by means of the state machine of FIG. 7. For each compressor state, it is indicated which information is transmitted (top), which packets are used (bottom) and how many bytes are sent for the header information (between brackets). Transitions among states are also indicated and their explanation is given below.

Initially, the compressor is in the IR state and all the static and dynamic part of the context must be transmitted at the decompressor. The transition from IR to FO can be made only if the number of lost packets at the observation time t 1p(t) is smaller than the number of lost packets at the observation time t-1 1p(t-1). These observation times are fixed points in time where the compressor registers the number of VoIP frames that could not be successfully delivered to the decompressor within a settable time threshold. 1p(t) is incremented by one for each L2CAP timeout event that is received at the L2CAP layer in the Bluetooth™ stack during the interval (t-1, t). The transition from FO to SO can only happen if the compressor registers that the incoming VoIP stream does not show irregularities (such as, for example, silence suppression in the voice coder). Once in the SO, the compressor reverts to FO if the IP stream shows irregularities. When in the FO state, if a NAK packet is received through the feedback channel indicating that the static context has been corrupted, then the compressor goes back to the IR state.

Mapping ROHC RTP on Bluetooth™:

The ROHC-BNEP algorithm described in the next section falls into the ROHC bi-directional optimistic approach, which is extensively described in “Robust Header Compression (ROHC): Framework and four profiles: RTP, UDP, ESP and uncompressed” by C. Borman et al. and referred to above.

The feedback channel utilization has been minimized to carry only context update requests from the decompressor to the compressor. Packet types used in the ROHC RTP profile can be found in C. Borman et al., section 5.2.7. The decompressor starts in unidirectional mode and sends a feedback packet back to the compressor indicating it wants to transition to the optimistic mode after it has acquired context information. As soon as the compressor receives such requests, it stops sending periodic IR updates and goes to O-mode, thus saving bandwidth.

In order to evaluate the effectiveness of the ROHC-BNEP RTP/UDP/IP header compression algorithm in a Bluetooth™ system, some considerations have to be made. First, the Bluetooth™ Logical Link Control and Adaptation Layer (L2CAP) will be considered, then the baseband error handling mechanisms will be revisited.

Link Layer Framing:

The L2CAP layer provides logical channels and segmentation and reassembly (SAR) functionality to the Bluetooth™ stack. A logical channel is identified by a channel ID (CID) and it is set-up by dedicated L2CAP signaling messages between peer entities, using an existing baseband connection. Several logical channels can be established between two BT devices over the same baseband connection. For each logical channel a link layer Maximum Transmission Unit (MTU) is defined, which limits the L2CAP maximum frame size. The L2CAP SAR functionality is such that an L2CAP frame is segmented into multiple baseband packets, which are transmitted in sequence.

Since the baseband layer does not allow us to distinguish between L2CAP connections, baseband packets belonging to different L2CAP frames cannot be interleaved. In other words, once the first packet of an L2CAP frame has been transmitted, all the remaining packets of the same logical connection must follow.

This characteristic implies that, if two applications are using the same logical channel (or even if they are using two different logical channels), a longer frame with low priority can delay the transmission of a shorter one with higher priority.

Therefore it is recommended to properly use the L2CAP MTU parameter to avoid these blocking effects. As an example we will consider a BT client with a VoIP application and one or more TCP/IP connections. The two applications have different characteristics since the first one is delay sensitive and has short packets while the second one does not have delay constraints but packets can be up to 1500 bytes long. To avoid delaying the real-time traffic, a small MTU has to be used also for the TCP/IP connection, even if this introduces large fragmentation overhead in the IP layer.

The two above applications have different reliability requirements: for the real-time traffic, a packet that is being delayed because of transmission errors beyond a certain threshold is no longer useful and can be dropped, while this is not true for the TCP/IP data connection.

An automatic flush timeout can be applied on each L2CAP logical channel with a settable value. In our simulations, a timeout of 12.5 ms has been used to discard VoIP frames.

In case TCP/IP and RTP/UDP/IP are simultaneously present on the same BT link as in our example above, it has to be evaluated whether to allow discarding also TCP/IP frames in order to improve the quality of the VoIP application. This choice depends on many factors and has implications on both the real-time and the data traffic (in the latter case TCP/IP retransmissions would have to be considered).

When applying the ROHC-BT algorithm in a Bluetooth™ system, the number of L2CAP timeouts of the delay sensitive logical channel plays a central role to increase error robustness of the header compression mechanism. In fact, L2CAP timeout events indicate that a frame has been lost, so the header compressor can use this information to increase the window, for example by choosing an appropriate ROHC packet type.

Error Handling:

The ARQ mechanism in the Bluetooth™ baseband is such that the receiver must positively acknowledge each baseband packet before the next packet is transmitted. If transmission errors occur either in the data packet or in the acknowledgement message, the packet must be retransmitted. Error conditions that cause packet retransmissions include:

Baseband packet access code not received;

Uncorrectable errors in the baseband packet header;

Uncorrectable errors in the packet payload (If only such an error condition occurs in the acknowledgement packet, no retransmission is triggered because the ACK field is carried in the packet header).

All the baseband packets that are part of the same L2CAP frame must be correctly received before the frame assembled at the receiver is passed to the upper layers. At the transmitter, all the baseband packets into which the L2CAP frame has been segmented must be positively acknowledged within a settable time to avoid an L2CAP timeout event.

When an L2CAP timeout event occurs, the transmitter flushes all the remaining baseband packets both in the L2CAP layer and in the host controller using the HCI_Flush command (see Bluetooth™ SIG, “Core Specifications, v1.1”, part H:1, section 4.7.4). This command resets all the pending retransmissions for a specified connection handle. Only when a new HCI data packet tagged as the start of a new frame is received, normal operation is resumed.

The recipient of the L2CAP connection is informed about the L2CAP timeout of the transmitter by using the Plush_Timeout option in the configuration of the L2CAP channel (see Bluetooth™ SIG, “Core Specifications, v1.1”, part D, section 6.2).

Point-to-Multipoint:

Some consideration should be given to the polling access scheme in the case when the VoIP transmitter is running in a Bluetooth™ slave and the master has other slaves connected to it.

First, the slave should request the master to be polled at a rate that is matched to the generation of VoIP packets (e.g. each 30 ms). This is accomplished by negotiating a suitable Tpoll with the command HCI_QoS_setup, which is translated into a LMP_quality_of_service_request.

In the case of a point-to-multipoint configuration, however, the unnumbered ARQ scheme of the Bluetooth™ baseband indicates that a packet sent by a slave to the master may be acknowledged the next time the master polls the slave (see Bluetooth™ SIG, “Core Specifications, v1.1”, part B, section 5.3.1). This means that L2CAP timeouts maybe triggered at the slave depending on the scheduling policy of the master.

Configuration:

The initial configuration process is shown in FIG. 3, in which the flow between the personal area network user (PANU) and the network access point NAP (AP₁₋ₙ). Upon first connecting to an access point AP₁₋ₙ the handset MT performs an SDP query to get information on the services supported by the access point AP₁₋ₙ. The access point AP₁₋ₙ must advertise both PAN and ROHC-BNEP capabilities, respectively for standard BNEP protocol (a PSM value is assigned) and for the new ROHC-BNEP protocol that is specified in this document (a dynamic PSM can be used for this purpose).

An L2CAP reliable connection is created first by requesting the BNEP-specific PSM. Then a second L2CAP connection is created by using the dynamic PSM value for ROHC-BNEP that had been advertised in the SDP record. This second connection will be configured as unreliable using the L2CAP Quality-of-Service (QoS) set-up messages. This allows number of retransmissions for a VoIP packet to be limited: in fact, if the packet has not been successfully delivered within a certain amount of time, it becomes useless for the receiver and can be discarded, thereby saving bandwidth. To this end, the L2CAP timeout needs to be coupled with the baseband flush command, which suspends packet retransmissions and frees all the involved buffers in the BT link manager. In summary, the mobile handset may need to configure two logical channels, one for carrying standard IP traffic and another for the compressed VoIP stream. Once the L2CAP logical channels have been set up, the mobile terminal and the access point must use them consistently, as explained in the next subsections.

In the event that only one L2CAP channel can be established between an access point AP and a mobile terminal MT, then the “unreliable” channel should be used also for data connections in order to protect the VoIP flow. Loss of data packets on the unreliable logical channel can be dealt with by higher layer protocols (e.g. TCP/IP).

Transmitter and Receiver Logic:

At the transmitter, the algorithm depicted in FIG. 4a can be used whenever a BNEP frame has to be delivered to L2CAP.

First of all the BNEP frame must be classified in order to understand whether it has to be compressed or not. In fact, only BNEP frames carrying RTP/UDP/IP packets must be processed with the proposed ROHC-BNEP algorithm.

The following BNEP header fields are checked:

BNEP destination address (peer must have ROHC capabilities)

BNEP protocol type (must be “IP” or “IPv6”, IEEE802.1p and IEEE802.1q must be interpreted as well for Ethernet frame tagging since they are used in LANs with QoS support)

IP protocol type (must be UDP)

UDP port (must correspond to H.323).

If the BNEP frame has to be compressed, its ROHC context is retrieved and the resulting compressed frame is sent to the L2CAP layer using the L2CAP CID (L-CID) that corresponds to the unreliable channel. If the frame does not have to be compressed, the L-CID of the reliable channel is used instead.

At the receiver, as depicted in FIG. 4b, if a frame arrives from the unreliable channel that corresponds to the ROHC-BNEP L-CID, it is assumed that ROHC-BNEP decompression has to be applied. After a successful reconstruction, the frame is delivered to the BNEP layer.

In cases where a compressed frame could not be correctly reconstructed, it is discarded in the decompressor. A negative ACK is sent back to the peer ROHC compressor, using the unreliable channel and the ROHC feedback packet type, after N2 consecutive compressed packets could not be reconstructed (see later sections for a description of the ROHC algorithm). N2 is set for example to 15.

A block diagram for the ROHC-over-BNEP arrangement is depicted in FIG. 5. The ROHC codec and all the related logic may be implemented in the form of a software product, which is run in association with the Bluetooth™ network interface software driver. This software product includes the BNEP and L2CAP layers, a frame classifier, the ROHC codec and a Management Entity (ME), which co-ordinates the various blocks. The ME can communicate with the BT baseband through the standard HCI interface (when present) and with the upper layers by means of operating-system specific mechanisms.

Each time a mobile terminal MT₁₋ₙ connects to an AP₁₋ₙ, the ME registers its MAC address and configures logical channels for it. In Bluetooth™, a logical channel is characterized by a couple of channel end-points, named L2CAP channel ID (L-CID). Upon channel set-up, each peer assigns its own local L-CID and sends it to the remote device. Therefore, for ROHC purposes, the following table can be built.

TABLE 9
ROHC-BNEP example configuration of an AP.

| MAC addr. | Local L-CID | Remote L-CID | ROHC | R-CID |
|---|---|---|---|---|
| MT1 | 1 | 10 | N | — |
| MT1 | 2 | 11 | Y | 0 |
| MT2 | 3 | 10 | Y | 0 |
| MT1 | 4 | 12 | Y | 1 |

In the example of Table 9, an AP₁ has two mobile terminals MT_{1,2} connected. MT1 has configured two logical channels, one for normal IP traffic and one for VoIP. This second channel will use a null ROHC Context ID. When MT2 connects to the access point AP₁, it configures a channel for VoIP: a null R-CID can be used also in this case. However, when MT1 configures another channel for a second RTP/UDP/IP/BNEP flow (4^{th} row), a different ROHC context must be used, because MT1 now has two real-time streams that have to be dealt with separately (for example, one voice channel and one video channel).

By applying the proposed robust header compression technique disclosed herein between the mobile terminals and access points, it is possible to save bandwidth and thereby handle a higher number of connections in the same piconet.

While the present invention has been particularly shown and described with respect to a preferred embodiment, it will be understood by those skilled in the art that changes in form and detail may be made without departing from the scope and spirit of the invention.

Glossary:

| | |
|---|---|
| ACL | Asynchronous Connection Less |
| AP | Access Point |
| BER | Bit Error Rate |
| BNEP | Bluetooth Network Encapsulation Protocol |
| BT | Bluetooth |
| CID | Context ID (in ROHC), Channel ID (in Bluetooth L2CAP) |
| IETF | Internet Engineering Task Force |
| IP | Internet Protocol |
| L2CAP | Logical Link Control and Adaptation Layer |
| LAN | Local Area Network |
| L-CID | L2CAP Channel Identifier |
| LM | Link Manager |
| MAC | Medium Access Control |
| ME | Management Entity |
| MT | Mobile Terminal |
| PAN | Personal Area Network |
| PSM | Protocol Switch Multiplexer |
| R-CID | ROHC Context Identifier |
| ROHC | RObust Header Compression |
| RSSI | Received Signal Strength Indication |
| RTP | Real Time Protocol |
| SDP | Service Discovery Protocol |
| TO | Timeout |
| UDP | User Datagram Protocol |
| VoIP | Voice over IP |

1. A method for packet-based wireless transmission between a first unit and a second unit, the method including a said unit:
a) converting a real-time bit stream into one or more payloads of predetermined maximum length;
b) applying one or more predefined headers to the or each said payload so as to generate packets suitable for transmission between said units in accordance with a predefined communications protocol;
c) encapsulating the or each said packet within a frame of an encapsulation protocol adapted for transporting the or each said packet across a wireless connection between said units; and
d) applying a predefined header compression technique to the or each said encapsulated packet.

2. A method according to claim 1, including generating the or each said payload from a said real time bit stream comprising Internet Protocol (IP) traffic, such as Voice-over-Internet-Protocol (VoIP), audio or visual streams.

3. A method according to claim 1, including performing a service discovery procedure between said first and second units and advertising said header compression technique during said service discovery procedure.

4. A method according to claim 1, including configuring one or more of segmentation, re-assembly and multiplexing services of said predefined communications protocol to carry a compressed bitstream.

5. A method according to claim 1, including applying said header compression by adding encapsulation protocol information to the context of a compressor and decompressor adapted to apply said header compression technique, said information comprising for example static header fields of said encapsulation protocol.

6. A method according to claim 1, said units comprising part of a Bluetooth™ network and said method including encapsulating the or each said packet using an encapsulation protocol comprising a Bluetooth™ Network Encapsulation Protocol (BNEP).

7. A method according to claim 6, including compressing with said header compression technique the or each said encapsulated packet into a single slot Bluetooth™ baseband packet, preferably by shrinking a combination of said predetermined headers and a BNEP header to a predetermined length, for example three bytes.

8. A method according to claim 1, including applying said header compression technique in the form of a Robust Header Compression (ROHC) framework, such as an ROHC approved by the Internet Engineering Task Force (IETF).

9. A method according to claim 8, including one or more of the following:
a) using the Real Time Protocol (RTP) profile for said packets;
b) using the IETF ROHC bi-directional optimistic approach (o-mode);
c) using small ROHC Context Identifiers (R-CID), with null R-CID being a default;
d) transmitting no Universal Datagram Protocol (UDP) checksum, optionally recalculating it at a decompressor;
e) considering, during any one packet flow, the whole encapsulation protocol header as part of the static context;
f) transmitting only the Real Time Protocol (RTP) Sequence Number and/or the Internet Protocol identity;
g) defining transitions among “Initialization and Refresh” (IR), “First Order” (FO) and “Second Order” (SO) states in a compressor and among “No Context” (NC), “Static Context” (SC) and “Full Context” (FC) states in a decompressor.

10. A method according to claim 1, including classifying encapsulation frames such that only predetermined said frames are compressed using said header compression technique.

11. A method according to claim 1, including applying headers to said payload in accordance with one or more of Real Time Protocol (RTP), Universal Datagram Protocol (UDP) and Internet Protocol (IP).

12. A method according to claim 1, including said units configuring a plurality of logical channels for communication therebetween, at least one said channel being dedicated to transport of said compressed encapsulated packets.

13. A method according to claim 1, including basing said header compression technique on Window-Least Significant Bit coding (W-LSB).

14. A method according to claim 1, including governing switching between compressor and decompressor states by providing a feedback channel between said units adapted for error recovery requests and, optionally, for acknowledgements of context updates.

15. A method according to claim 1, including a said unit receiving a succession of said compressed encapsulated frames segmented into baseband packets, positively acknowledging each said packet before a next said packet is transmitted and, in the event that a transmission error occurs in either the latest said packet or an acknowledgement message, said latest packet is retransmitted.

16. A method according to claim 15, including retransmitting said packet in the event of at least one of the following:
a) a baseband packet access code is not received;
b) an uncorrectable error is present in a baseband packet header; or
c) an uncorrectable error is present in said payload of said packet.

17. A method according to claim 1, including limiting a number of retransmissions for a said compressed encapsulated frame, for example by setting a timeout for successful delivery of said frame.

18. A software product for executing packet-based wireless transmission between a first unit and a second unit, the product including code for:
a) converting a real-time bit stream into one or more payloads of predetermined maximum length;
b) applying one or more predefined headers to the or each said payload so as to generate packets suitable for transmission between said units in accordance with a predefined communications protocol;
c) encapsulating the or each said packet within a frame of an encapsulation protocol adapted for transporting the or each said packet across a wireless connection between said units; and
d) applying a predefined header compression technique to the or each said encapsulated packet.

19. A packet based wireless communications arrangement comprising a first unit adapted to communicate information to a second unit substantially in real-time, said first unit being adapted to:
a) convert a real-time bit stream into one or more payloads of predetermined maximum length;
b) apply one or more predefined headers to the or each said payload so as to generate packets suitable for transmission between said units in accordance with a predefined communications protocol;
c) encapsulate the or each said packet within a frame of an encapsulation protocol adapted for transport of the or each said packet across a wireless connection between said units; and to
d) apply a predefined header compression technique to the or each said encapsulated packet.

20. A wireless communications arrangement according to claim 20, said first unit being operable in accordance with the Bluetooth™ protocol, said encapsulation protocol preferably comprising a Bluetooth Network Encapsulation Protocol (BNEP) and said header compression technique preferably being compatible with an Internet Engineering Task Force (IETF) Robust Header Compression (ROHC) technique.

21. A wireless communications unit adapted to operate in accordance with the method claim 1 and preferably configured at least temporarily as at least one of a master unit and a slave unit of Bluetooth™ communications network.
